(19) United States
(12) Patent Application Publication
(10) Pub. No.: US 2008/0291983 A1
(43) Pub. Date: Nov. 27, 2008

(54) SIGNAL ADJUSTMENT DEVICE

(75) Inventor: Steven L. Myers, Parkland, FL (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Peregrine Electronics Group, Inc., Las Vegas, NV (US)

(21) Appl. No.: 11/935,763

(22) Filed: Nov. 6, 2007

Related U.S. Application Data
(60) Provisional application No. 60/857,400, filed on Nov. 7, 2006.

(51) Int. Cl. H04B 1/40; H04B 1/16; H04L 27/08

(52) U.S. Cl. 375/219; 375/345; 455/249.1; 455/73

(57) ABSTRACT

A signal processor and method for receiving a digital signal and providing an output signal to a signal receiving device includes a receiver for receiving a digital signal from an antenna and a control circuit for adjusting signal attenuation of the digital signal and generating an output signal. The control circuit includes a variable signal attenuator. The control circuit is operable to sample the output signal and to adjust the variable signal attenuator to adjust signal attenuation and the output signal toward a target output level. The adjusted output signal is communicated to the signal receiving device. The signal processor may include a splitter that receives the output signal of the variable signal attenuator and provides two output signals, one of the output signals being communicated to the signal receiving device and another of the output signals being sampled by the control circuit.

### CROSS REFERENCE TO RELATED APPLICATION

The present application claims the benefit of U.S. provisional application, Ser. No. 60/857,400, filed Nov. 7, 2006, which is hereby incorporated herein by reference in its entirety.

### FIELD OF THE INVENTION

The present invention relates generally to communication devices and, more particularly, to a communication device or modem having an increased or enhanced sensitivity and high dynamic range.

### BACKGROUND OF THE INVENTION

Typical wireless modems exploit highly integrated circuits to provide a low cost solution for consumers. Presently, there is pressure to reduce the cost of such modems by consolidating the radio frequency (RF) and digital electronics into a single circuit board or substrate, yielding a tradeoff between integration/economy and performance.

Digital electronic devices typically generate noise over a broad spectrum of frequencies. Receiver circuits are tasked with the recovery of the very weak signals and require a quiet environment to achieve maximum sensitivity. Known communication protocols, such as orthogonal frequency division modulation (OFDM), a popular WLAN protocol (802.11g), is very sensitive to noise and/or circuit linearity. Thus, the coexistence of these subsystems into a single integrated circuit often results in the reduction of the overall modem sensitivity and the dynamic range of the modem. The “dynamic range” of the modem is the spectrum of signal strengths (amplitudes) over which a radio device can function nominally, and is typically set at its low end by the receiver's sensitivity and at its upper end by the receiver's saturation or distortion or combination thereof. Often, other factors, such as the data recovery scheme or algorithm, can further narrow the dynamic range of the modem.

Many known modems have relatively poor sensitivities due to the above factors, with typical numbers ranging from about −85 dBm to −70 dBm for a 1 Mbps data transfer rate with a zero dBi antenna. Use of a Frequency Hopping Spread Spectrum (FHSS, or 802.11) modem may achieve sensitivities of up to about −92 dBm with a modulation that is less energy efficient. Information energy in a FCC Part 15 compliant FHSS modem drops down to about 20 dB at 0.5 MHz of spectrum, such as shown in FIG. 1.

An OFDM protocol may provide a spectrally efficient means for delivering information, since the allowed bandwidth is well utilized (for example, and as can be seen with reference to FIG. 2, the energy may be almost uniformly spread over an allowed bandwidth). Thus, because of the improved spectrum efficiency, an OFDM receiver may provide for greater sensitivity than an FHSS receiver for the same or about the same data throughput. Typically, the cost or tradeoff for a highly integrated modem circuit is a reduction of the performance of about 6 dB (¼^{th}performance) to about 20 dB ( 1/100^{th} performance) or more.

Typical modems, such as those referenced above, are based on Direct or Single Low-IF Conversion designs, where the 2.4 or 5 GHz signal is translated directly to baseband. In traditional receivers, signals are progressively translated to lower frequencies (typically to 1 or 2 values, called the intermediate frequencies or “IFs”) prior to conversion to baseband, allowing for progressively tighter filtering at each stage. At baseband, demodulation or the recovery of the original information typically occurs.

Such direct conversion (DC) schemes are often popular because they require fewer filter stages and because the bulk of the amplification can be performed at lower frequencies, where inexpensive or less costly CMOS technology may be exploited. The simplicity of DC architectures, however, does not come without cost. In order to avoid having to deal with Local Oscillator self-jamming, downconversion to a very low IF is the preferred DC implementation. Such a low IF is typically one or a few channels high. Thus, such a method may result in the existence of an image channel (a receiver typically simultaneously receives signals in the desired channel and in all image frequencies). To reduce the receiver sensitivity at the image frequency, an imageless mixer may be used, which attenuates the unwanted component by approximately 40 dB ( 1/10000^{th}). In situations where the desired signal is far, and a near interfering signal (such as another Wi-Fi signal, a Bluetooth device or the like) exists within the image channel, the modem may have difficulty in communicating while the image is being transmitted. This may also be the case for any very strong signal that is at or very near the image frequency.

The desire for low power consumption and high integration is responsible for saturation at modestly low power levels (such as at about −20 dBm to −5 dBm signals). For most Client Premises Equipment (CPE), such levels are generally suitable, since the height at which modems are generally placed is at or about one meter (such as at a desktop), and the modems are primarily used indoors. However, when the same modem is located on a tower or outdoors, the modem is exposed to substantially more sources of RF energy, as its radio horizon extends due to its greater height. Thus, poor sensitivity, front end saturation, distortion and limited filtering are at least partially or substantially responsible for the short range of such known Wi-Fi components. WiMax (802.16), a modem standard developed for medium to wide areas (which has a longer range than typical Client Premises Equipment, and in the order of a few miles or thereabouts), also suffers from equipment limitations at the infrastructure, where the existence of strong signals can have a high probability, especially within the 2.4 GHz ISM spectrum. Formulas for radio horizon are as follows:

horizonₖₘ=3.569×\sqrt{heightₘₑₜₑᵣₛ};

or

horizonₘᵢₗₑₛ=1.23×\sqrt{height_{feet}};

where the effective horizon is obtained by adding the horizons of both the transmitting antenna/antennae and the receiving antenna.

In order to improve receiver sensitivity, a Low Noise Amplifier (LNA) having a low noise figure may be added to the modem. If the amplifier has sufficient gain to control the system's overall noise figure of merit, the sensitivity of the receiver may be substantially or primarily determined by the LNA. For example, a 20 dB LNA with a 1-2 dB Noise Figure would provide sufficient gain to achieve this goal.

Increasing the front end gain in the receiver often penalizes the receiver in the presence of strong signals, as the strong signals will also be amplified by the same amount. Further, saturation may be accelerated by the addition of an LNA. Added front end gain, more often than not, reduces the receiver's dynamic range, because the sensitivity increases only by a fraction of the added gain, while the saturation is accelerated by the full amount of the gain. For example, if a modem has a sensitivity of −85 dBm and a saturation at −15 dBm, its dynamic range is −15 dBm-(−85 dBm)=70 dB. By adding a 20 dB LNA, for example, the sensitivity may improve to about −92 dBm and the saturation level may be worsened by about 20 dB (−15 dBm −20 dB=−35 dBm), which yields a new dynamic range of −35 dBm-(−92 dBm)=57 dB. This represents a net operating range reduction of 13 dB (70 dB-57 dB) for the benefit of 7 dB more sensitivity. In a rural application, such a trade might be beneficial, however, in general, this would not represent a substantial improvement.

Therefore, there is a need in the art for a modem or communication device that provides enhanced sensitivity and a high dynamic range and that overcomes the shortcomings of the prior art.

### SUMMARY OF THE INVENTION

The present invention provides a signal enhancement device for a communication device or modem or signal receiving device, wherein the signal enhancement device adjusts or attenuates or modulates a signal, such as a digital signal, received by an antenna to provide an enhanced signal to the communication device or modem or signal receiving device. The signal enhancement system or device of the present invention adjusts the gain of the signal to prevent saturation, while optimizing the effective dynamic range of the system.

According to an aspect of the present invention, a signal processor for receiving a digital signal and providing an output signal to a signal receiving device includes a receiver for receiving a digital signal from an antenna, and a control circuit for adjusting signal attenuation of the digital signal and generating an output signal. The control circuit includes a variable signal attenuator. The control circuit is operable to sample the output signal and to adjust the variable signal attenuator to adjust signal attenuation and the output signal toward a target output level. The output signal is communicated to the signal receiving device.

The control circuit may be operable to compare the power of the output signal with a target input power of the signal receiving device. The control circuit may increase signal attenuation by the variable signal attenuator to limit the gain of the signal processor in response to the control circuit determining that the power level of the output signal is at or above the target input power level. The control circuit thus may increase signal attenuation to limit the gain of the signal processor until the measured power of the output signal and the target input power level of the signal receiving device substantially match. The signal processor may comprise a directional coupler or splitter that receives the output signal and provides two output signals, one of the output signals being communicated to the signal receiving device and another of the output signals being sampled by the control circuit.

Optionally, the signal processor may be selectively operable as a transmission enhancement device to enhance a transmitted signal received from a transmitting device associated with the signal receiving device. The signal processor may be selectively switched between a received signal enhancement device and a transmission enhancement device. The signal processor may be selectively switched in response to a determination that a signal at the signal processor is above or below a threshold level.

The signal processor may communicate the output signal to a receiver of a modem or may communicate the output signal to a receiver of a wireless cable television or to any other suitable signal receiving device.

According to another aspect of the present invention, a method of enhancing a digital signal received by an antenna for communication to a signal receiving device includes receiving a digital signal from an antenna. The signal attenuation of the digital signal is adjusted and an output signal is generated. The output signal is sampled and the output signal is compared to a target output level. The signal attenuation and the output signal are adjusted toward the target output level. The adjusted output signal is communicated to the signal receiving device.

Therefore, the present invention provides a signal processor or signal enhancement system or circuit that is operable to receive a signal and adjust or modulate or attenuate the signal so that an adjusted or modulated or attenuated output signal is provided to a signal receiving device. The system adjusts or modulates or attenuates the signal to match or substantially match the output signal of the signal processor with the target signal for the signal receiving device at any given time. Thus, the signal processor of the present invention may provide an enhanced or optimum signal to the signal receiving device to avoid saturation and enhance the dynamic range of the system. Optionally, the signal processor of the present invention may also function to enhance the signal transmitted by the signal receiving device (such as a modem or the like) so that an enhanced transmitted signal is provided to an antenna. Optionally, the signal processor of the present invention may selectively function in a receive mode and a transmit mode and may switch from one to the other in response to the control determining a power level or output level of a signal at the signal processor.

These and other objects, advantages, purposes and features of the present invention will become apparent upon review of the following specification in conjunction with the drawings.

### BRIEF DESCRIPTION OF THE DRAWINGS

FIG. 1 is a graph showing that the information energy of a known FCC Part 15 compliant FHSS modem drops down to about 20 dB at 0.5 MHz;

FIG. 2 is a graph showing an allowed bandwidth of a known OFDM device;

FIG. 3 is a schematic of a signal enhancing circuit or system in accordance with the present invention;

FIG. 4 is a schematic of another signal enhancing circuit or system in accordance with the present invention;

FIG. 5 is a schematic of another signal enhancing circuit or system in accordance with the present invention; and

FIG. 6 is a schematic of another signal enhancing circuit or system in accordance with the present invention, as implemented with a television antenna and receiver.

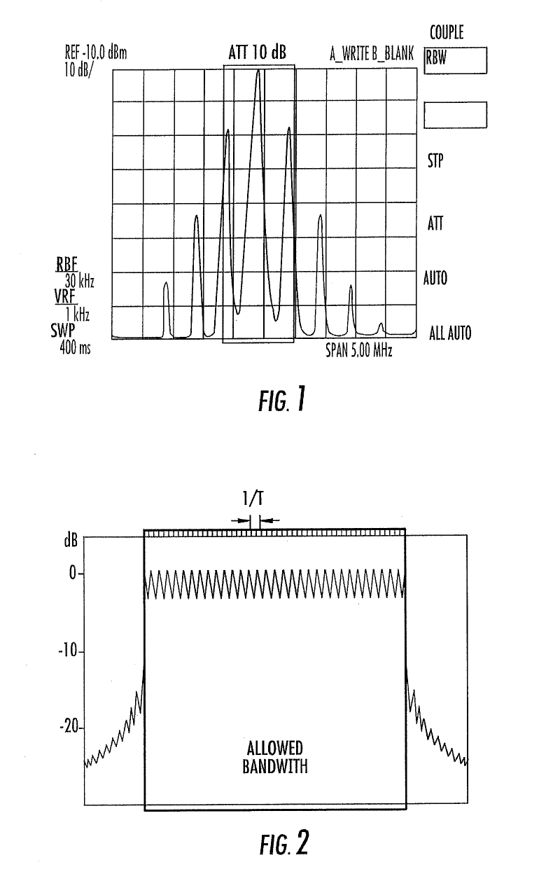

### DESCRIPTION OF THE PREFERRED EMBODIMENTS

It is desired to improve the sensitivity of a modem or communication device without significantly reducing or hurting the dynamic range or the device and, preferably, by extending the dynamic range of the device. In order to achieve such an improved device, a non-linear solution may be implemented in which either feedback or intelligence is used to adjust the gain, as well as other parameters, if desired. Thus, the signal enhancement system of the present invention operates to provide the signals as they are desired for optimal overall performance, as discussed below.

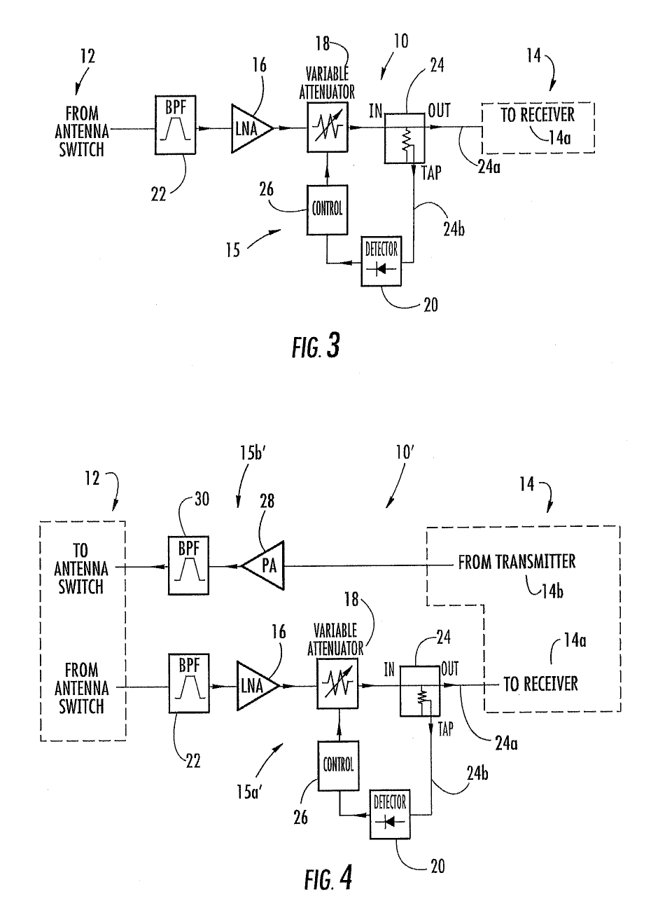

Referring now to the drawings and the illustrative embodiments depicted therein, a signal enhancement system or circuit 10 is connected or positioned between an antenna switch 12 (which receives a signal that is received by an associated antenna) and a receiver 14a (such as a receiver of a modem 14 or other communication device) and is operable to adjust the gain of the system or circuit without decreasing or substantially decreasing the effective dynamic range of the system (FIG. 3). Signal enhancement system 10 comprises a control circuit 15 that includes a low noise amplifier (LNA) 16, a variable signal attenuator or variable attenuator 18 and a detector or detector circuit 20, which provide added output dynamic range and sensitivity, as discussed below.

As can be seen in FIG. 3, the signal enhancement system 10 is positioned or connected between antenna switch 12 and receiver 14a and adjusts the gain to limit or substantially preclude saturation, while enhancing or optimizing the effective dynamic range of the system. Optionally, signal enhancement system 10 may include a low loss, band pass filter (BPF) 22, which controls or filters out band signals and noise. LNA 16 provides the lowered noise figure response and raises the incoming signal levels by its gain. The signal that is output from the LNA 16 is received by variable attenuator 18, which is adjustable to control the overall gain of the circuit or system 10. A tap or splitter or directional coupler 24 splits or taps the output signal of the variable attenuator 18 to provide two outputs from the variable attenuator 18. One of the output signals 24a is communicated to the modem receiver 14a, while the other output signal 24b is communicated to the detector or detector circuit 20 for sampling of the signals by the detector circuit 20.

Detector circuit 20 measures and monitors the power of the output signal 24b of splitter 24 (and thus is measuring and monitoring the power of the output signal 24a of the circuit or system 10), and a control or signal processor 26 is operable to compare the output power with the desired or threshold modem input power (typically the maximum level for linear operation of the modem). If the control 26 determines that the output power exceeds the desired or threshold input power level, the control controls or adjusts variable attenuator 18 to increase the signal attenuation by the variable attenuator 18, which limits the gain of system 10. The control or adjustment of the variable attenuator 18 is continued until the measured output level matches or substantially matches the desired or threshold modem input power level.

Since the gain of the system 10 is adjusted or reduced to prevent saturation of the system, there is little or no penalty to the dynamic range by the introduction of the signal enhancement circuit or system 10. Further, because the gain of the system is thus at its maximum at low output levels, the effective dynamic range of the signal enhancement circuit is increased.

To illustrate the benefits of the present invention, a typical or conventional modem is discussed below. For example, for a typical or conventional modem, if the modem has a sensitivity of −85 dBm and a saturation at −15 dBm, such a modem has a dynamic range of about 70 dB (−15 dBm-(−85 dBm)=70 dB). By adding a 20 dB LNA, the sensitivity may improve to an about −92 dBm, but the saturation level is worsened by 20 dB (−15 dBm −20 dB=−35 dBm). Thus, the system would yield a new dynamic range of about 57 dB (−35 dBm-(−92 dBm)=57 dB). This represents a net operating range reduction of about 13 dB (70 dB-57 dB) for the benefit of about 7 dB more sensitivity.

However, with the signal enhancement circuit or system of the present invention, the effective dynamic range with a similar circuit may be about 77 dB (−15 dBm-(−92 dBm)=77 dB). This is because the enhancement of the sensitivity to about −92 dBm is not countered by the reduction in saturation level, since the control circuit of the present invention adjusts the signal attenuation to limit or substantially preclude saturation. Thus, the effective dynamic range of the circuit has been increased, allowing the modem to operate beyond its previously existing limits.

Optionally, if the variable attenuator is capable of even greater loss than the gain of the LNA, further extension can be had with the signal enhancement system of the present invention. For example, a 31 dB attenuator is fairly common and commercially available. Choosing this value in the example above may introduce a net loss of about −11 dB (+20 dB+−31 dB) on a very strong signal. Then, saturation may happen at about −4 dBm (−15 dBm-(−11 dB)), and the dynamic range may thus increase to about 88 dB (−4 dBm-(−92 dBm)).

The signal enhancement circuit or system of the present invention thus serves as an Automatic Gain Control (AGC), which is independent of the modem's own internal automatic gain control. The two AGCs, however, have different functions and meanings. The signal enhancement circuit of the present invention controls the overall input band power/energy level to prevent or limit saturation at the modem receiver, while the modem's internal control controls the in-channel gain for optimum demodulation.

Optionally, the detector circuit 20 may comprise a diode and a low pass filter, or, for greater operating range, a Logarithmic Detector (LD), such as Analog Devices AD8313 (2.4 GHz only) or AD8318 (up to 6 GHz), or other suitable device. The dynamic range of a diode detector is typically of the order of 35-40 dB, while that of a Log-Detector may be about 40-60 dB. Other suitable filters and detectors may be implemented while remaining within the spirit and scope of the present invention.

Optionally, the signal enhancement circuit of the present invention may incorporate benefits in a transmit mode as well. For example, a linear (class A) power amplifier may be added to boost transmitter output by about 5 dB to about 12 dB. Over land, an increase of 10-12 dB typically doubles the range of a radio link.

A signal enhancement circuit having such a power amplifier is schematically shown in the diagram or schematic of FIG. 4, where the signal enhancement circuit or system 10′ includes a received signal enhancement portion or circuit 15a′ and a transmitted signal enhancement portion or circuit 15b′. Received signal enhancement circuit 15a′ is connected between an antenna or antenna switch 12 and a receiver 14a of a modem 14, such as in a similar manner as described above, while transmitted signal enhancement circuit 15b′ (which includes a power amplifier 28) is positioned between a transmitter 14b of the modem 14 and the antenna or antenna switch 12 to boost the transmitter output of the modem. Optionally, transmitted signal enhancement circuit 15b′ may include a band pass filter 30, which may be positioned between the power amplifier 28 and the antenna switch 12 to filter the transmitted signal. The received signal enhancement portion or circuit 15a′ may be substantially similar to signal enhancement circuit 10, discussed above, such that a detailed discussion of the signal enhancement circuits need not be reported herein. The similar components of the systems are shown with like reference numerals in FIGS. 3 and 4.

Optionally, the signal enhancement system or circuit of the present invention may include other components or functions, such as a tunable notch filter, in which the strongest signal not belonging to the network may be eliminated to enhance or maximize gain in a near (foe)-far (friend) situation. Optionally, and alternately, a narrowband filter just covering the channel of interest and any adjacent neighbors may be installed for fixed operations or the like.

The signal enhancement circuit of the present invention may be installed on a modem's printed circuit board to function as described above. However, it is envisioned that the circuit may operate as a stand alone device. In such an application, the circuit may be connected or implemented between the antenna and the modem receiver. The addition of intelligence and a Transmit-Receive (T-R) switch (discussed below) may allow the circuit to operate as a stand alone transmit/receive signal enhancement device. Optionally, the circuit may be installed at the antenna, where it can offer benefits to the communications system or network.

For example, and as shown in FIG. 5, a stand-alone signal enhancement circuit or system 110 may be connected between an antenna 112 and a modem 114 (such as to a receiver of the modem 114 as described above). Antenna 112 may include an optional low loss, band pass filter 122 (BPF), which controls or filters out band signals and noise, such as described above. Signal enhancement system 110 includes a signal control circuit 115a having a Low Noise Amplifier (LNA) 116, a variable attenuator 118, a detector circuit 120, a tap or splitter 124 and a control or processor 126, such as in a similar manner as described above. However, the signals are selectively provided or communicated to the signal enhancement circuit 115a via one or more switches, as discussed below.

Signal enhancement system 110 also includes a transmission enhancement portion or circuit 115b that may be connected between a transmitter of modem 114 and antenna 112 and that may enhance or boost the transmission of the modem. In the illustrated embodiment, transmission enhancement circuit 115b includes a power amplifier 128 that boosts the transmitter output of the modem to provide a boosted output signal to the antenna 112.

Signal enhancement circuit 110 further includes a switch 132 at or connected to or in communication with the antenna 112 and a second switch 134 at or connected to or in communication with the modem 114 (such as between the variable attenuator 118 and splitter 124 as shown in FIG. 5). Optionally, a band pass filter 136 may be located between switch 134 and splitter 124, as also shown in FIG. 5, to filter the signal communicated by and enhanced by signal enhancement circuit 110.

The switches 132, 134 may be selectively switched (such as via a control signal 126a of control 126) depending on the function (transmit or receive) that is appropriate for the modem at any given time (as may be determined by control 126, as discussed below). For example, when the switches 132, 134 are set as shown in FIG. 5, the system or circuit 110 receives a signal at antenna 112 and operates as a received signal enhancement system to adjust the output signal to the modem in a manner that limits or substantially precludes saturation, such as described above.

Because the received signal enhancement circuit 115a may function substantially similar to signal enhancement circuit or system 10, discussed above, a detailed discussion of the signal enhancement circuits or systems need not be repeated herein. Alternately, when the switches 132, 134 are set to the other setting, for example, the signal enhancement system 110 may function as a transmission boosting system to boost the transmission power level of the modem, such as in a similar manner as described above with respect to transmitted signal enhancement circuit 15b′.

As can be seen in FIG. 5, the splitter 124 provides an output 124b to detector 126, where the output signal 124b may be from the antenna (via switch 132, LNA 116, variable attenuator 118 and switch 134) when the system 110 is in the receive mode, or may be from the modem 114 when the system 110 is in the transmit mode. Thus, in such an application, the detector 120 should be able to sustain sizeable signal power levels (typical modem transmit powers may be between +6 dBm (4 mW) to +20 dBm (100 mW) or thereabouts). Optionally, the detector may have a wide dynamic range to simultaneously accommodate “receive” and “transmit” functions.

For example, a logarithmic detector may be selected that has adequate operating range as a single detector. Another option is to have a pair of detectors having narrow ranges, one for a transmit operation and one for a receive operation.

The control circuit of the present invention thus may play a dual roll with the modem. When the power levels measured by detector 120 and/or control 126 are large or substantially large or relatively large (such as when the transmit signal from the modem is large), the circuit may adjust or switch or control (such as via a switch control signal 126a from control 126 to switches 132, 134) to a transmit mode and operate in the transmit mode until the modem stops transmitting. When the circuit detects this condition (detects that the modem stops transmitting), the switch may return to its default or receive position (such as via the switch control signal 126a from control 126 to switches 132, 134). When in the receive mode, the control circuit adjusts the variable attenuator 118 to achieve the target receiver input level, such as in a similar manner as described above with respect to signal enhancement system 10.

The control block or circuit or system of the present invention may be implemented with either analog or digital electronics. Additional functions, such as an automatically adjustable notch filter and associated circuitry may bias the choice of technology further. The decision of “transmit” or “receive” preferably occurs very quickly to minimize any potential damage to the LNA or the variable attenuator. In this regard, a number of fast (about 5 to 50 nanoseconds), low cost switches are commercially available in the marketplace, such as the Hittite HMC 536MS8G (2.4 and 5 GHz), or the HMC544 (2.4 GHz only) or the like. Other suitable switches and circuitry may be utilized without affecting the scope of the present invention.

The band pass filters implemented in such bi-directional circuits or systems such as described above are desirably of a ceramic composition. This is because such ceramic band pass filters or devices typically have greater linearity and can typically tolerate larger power levels than conventional or known or typical 2-port SAW filters. Because such filters are known in the art, a detailed discussion of these filters need not be included herein.

Optionally, in addition to or alternate to the Wi-Fi and WiMax type applications, the signal enhancement circuit or system of the present invention may be equally suitable for use with wireless cable television, because receivers designed for wireless cable television may also suffer from a poor dynamic range. For example, a television set top receiver may have a sensitivity of about −70 dBm and a saturation level of about −40 dBm. This means that the dynamic range may only be about 30 dB. At about −70 dBm, the image may be poor with visible snow, and at about −40 dBm, the image colors may begin to distort.

Typical or conventional wireless cable TV antennae are fixed and normally installed by experienced technicians. When such antennae are installed, the antennae are positioned/aimed with the aid of a portable receiver that reports signal strength. The technicians generally try to center the antenna's output to a level of about 0 dBmV (dB with respect to 1 mV at 75 ohms, a cable television standard), which is approximately −50 dBm. Thus, the set up of such antennae may be complicated and time consuming, and the cost associated with setting up such wireless cable TV antennae may be substantial due to the labor by the experienced technician, which is often upwards of about 1 to 2 hours of time.

The signal enhancement circuit or system of the present invention may function in a similar manner as the technician/set up of known wireless TV systems. Thus, an antenna having a signal enhancement circuit such as described herein with similar gain (about 30-60 dB) may achieve or realize a significant increase in dynamic range. Such a benefit would allow wireless TV carriers to hire and deploy fewer technicians, and might even allow the end-users to self-install the systems, thereby eliminating the initial investment of labor or at least minimizing the initial investment, since even installations by the experienced technicians would be much quicker, since the systems would be more of a “plug-and-play” type system. Further, such a signal enhancement circuit or system may substantially reduce service calls that are typically made for repositioning or adjustment of previously deployed antennae, which are often made necessary due to nearby new construction, changes in foliage, marginal installation, and accidental movement of the antenna, or equipment malfunction. The signal enhancement circuit of the present invention may be operable to partially or substantially compensate for any and all of the situations, except, of course, for any hardware malfunction itself.

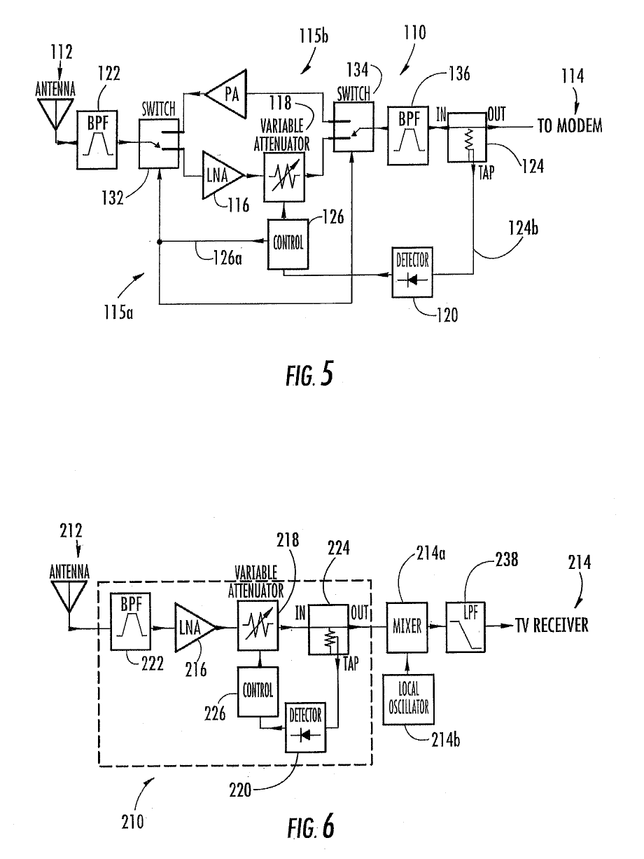

For example, and with reference to FIG. 6, a signal enhancement system 210 may be positioned between the antenna 212 and the mixer 214a at the TV receiver 214. In such an application, the antenna 212 may convert electromagnetic energy to a voltage/current, such as is known in the art. The dynamic range extension may then be provided by the signal enhancing circuit 210, whereby the output signal may be mixed to translate MMDS frequencies (2.1 GHz to 2.8 GHz) to the UHF TV range (400-900 MHz). In order to provide such a function, the mixer 214a may subtract the local oscillator frequency (as received from a local oscillator 214b) from the incoming MMDS signal. The output is then cleaned up with a low pass filter 238 to produce the desired signal to the TV receiver. The output of the TV receiver is typically a female type F connector, which is the industry standard for cable television.

Such MMDS blocked downconverters (LNBs) are commercially available from a variety of sources, such as California Amplifier, Channel Master, Viewsonics and the like. However, such off-the-shelf LNBs do not have the nonlinear feedback of the signal enhancement circuit of the present invention and, thus, do not provide for the improved dynamic range of the receiver. Instead, such conventional LNBs rely on the training and skill of the technician for optimal level setting.

As shown in FIG. 6, signal enhancement system or circuit 210 may be substantially similar to signal enhancement system 10, described above, and includes a band pass filter 222, a low noise amplifier or LNA 216, a variable attenuator 218, a tap or splitter 224, a detector 220 and a control or processor 226. Signal enhancement system 210 is positioned between or in communication between the antenna 212 and the mixer 214a at the TV receiver 214, and operates to adjust the signal attenuation to limit or substantially preclude saturation at the mixer or receiver, such as in a similar manner as described above. Because signal enhancement system 210 may be substantially similar to signal enhancement system 10, discussed above, a detailed discussion of the signal enhancement systems need not be repeated herein.

Therefore, the present invention provides a signal enhancement system or circuit that is operable to receive a signal from an antenna and adjust or modulate or attenuate the signal so that an adjusted or modulated or attenuated output signal is provided to a modem or television or other suitable or applicable signal receiving device. The signal enhancement system adjusts or modulates or attenuates the signal to match or substantially match the output signal of the signal enhancement system at any given time with a target or desired or appropriate signal for the modem or signal receiving device. Thus, the signal enhancement system of the present invention may provide an enhanced or optimum signal to the signal receiving device to limit or substantially preclude saturation at the signal receiving device and to enhance the dynamic range of the system. Optionally, the signal enhancement system of the present invention may also function to enhance the signal transmitted by the modem or the like so that an enhanced transmitted signal is provided to the antenna. Optionally, the signal enhancement system of the present invention may selectively function in a receive mode and a transmit mode and may switch from one to the other in response to the control determining a power level or output level of a signal at the signal enhancement system. The signal enhancement signal may be a stand-alone device or system or may be incorporated into the antenna and/or the modem or signal receiving device.

Changes and modifications to the specifically described embodiments may be carried out without departing from the principles of the present invention, which is intended to be limited only by the scope of the appended claims, as interpreted according to the principles of patent law.

1. A signal processor for processing a received signal and generating an output signal to a signal receiving device, said signal processor comprising:
a variable attenuator adapted to process said received signal and generate said output signal; and
a control circuit for adjusting an attenuation level of the variable attenuator, said control circuit operable to compare said output signal to a target output level and adjust the attenuation level of the variable attenuator such that said output signal moves toward the target output level.

2. The signal processor of claim 1 further comprising a splitter that receives said output signal of said variable attenuator and provides two output signals, one of said output signals being communicated to the signal receiving device and another of said output signals being sampled by said control circuit.

3. The signal processor of claim 1, wherein said target output level is a power level.

4. The signal processor of claim 3, wherein said control circuit is operable to compare the power of said output signal with a target input power level of the signal receiving device.

5. The signal processor of claim 4, wherein said control circuit increases signal attenuation by said variable attenuator to limit the gain of said signal processor in response to said control circuit determining that the power of said output signal is at or above the target input power level.

6. The signal processor of claim 5, wherein said control circuit and said variable attenuator increase signal attenuation to limit the gain of said signal processor until the measured power of said output signal and the target input power level of the signal receiving device substantially match.

7. The signal processor of claim 1, wherein said signal processor is selectively operable as a transmission enhancement device to enhance a transmitted signal received from a transmitting device associated with the signal receiving device.

8. The signal processor of claim 7, wherein said signal processor is selectively switched between a received signal enhancement device and a transmitted signal enhancement device.

9. The signal processor of claim 8, wherein said signal processor is selectively switched in response to a determination that a signal at said signal processor is above or below a threshold level.

10. The signal processor of claim 1, wherein said signal processor communicates said output signal to a receiver of a modem.

11. The signal processor of claim 1, wherein said signal processor communicates said output signal to a wireless cable television receiver.

12. A method of enhancing a signal received by an antenna for communication to a signal receiving device, said method comprising:
passing the signal through an attenuator to generate an output signal;
comparing said output signal to a target level;
adjusting said attenuator such that said output signal moves toward said target level; and
communicating said adjusted output signal to the signal receiving device.

13. The method of claim 12 further comprising enhancing a transmitted signal transmitted by a transmitter associated with said signal receiving device.

14. The method of claim 13 further comprising selectively functioning to adjust signal attenuation of the digital signal received by the antenna and to enhance the transmitted signal.

15. The method of claim 12, wherein adjusting said attenuator comprises adjusting signal attenuation of the signal via a signal processor comprising a variable signal attenuator.

16. The method of claim 13 further comprising measuring and monitoring the power of said output signal, and further comprising comparing the power of said output signal with a target input power level of the signal receiving device.

17. The method of claim 16 further comprising increasing signal attenuation by said variable signal attenuator to limit the gain of said signal processor in response to determining that the power of said output signal is at or above the target input power level.

18. The method of claim 17 comprising increasing signal attenuation to limit the gain of said signal processor until the measured power of said output signal and the target input power level of the signal receiving device substantially match.

19. The method of claim 13 wherein enhancing the transmitted signal includes amplifying a power of the transmitted signal.
